(19) United States
(12) Patent Application Publication
(10) Pub. No.: US 2005/0172874 A1
(43) Pub. Date: Aug. 11, 2005

(54) Finger type seed meter back plate seeding device

(76) Inventor: Michel Bellefroid, St-Armand (CA)

Correspondence Address: INVENTARIUM;Suite 1607, 4050 Rosemont Blvd, Montreal, QC, H1X 1M4, CA

(21) Appl. No.: 11/048,955

(22) Filed: Feb. 1, 2005

Related U.S. Application Data
(60) Provisional application No. 60/542,227, filed on Feb. 6, 2004.

(51) Int. Cl. A01C 7/00; A01C 9/00

(52) U.S. Cl. 111/177

(57) ABSTRACT

An improved finger type seed meter back plate seeding device for farming has a modified back plate has a wall having a circumferential groove on over half of the inner perimeter. This groove helps in improving the way seeds are presented to fingers and ultimately the exit hole. It reduces the incidence of jamming of seeds or of seeds being missed by the fingers which take seeds to the exit hole. This groove has three main variations to accomodate various sizes and shapes of seeds: A groove with and added side bump which rotates flat seeds so that their flat side is parallel to the bottom of the groove, a groove with a narrowing which funnels the seeds for a better grasping by the fingers, and a groove with a combination side bump and narrowing.

This application claims priority based on provisional patent No. 60/542,227 filed on Feb. 6, 2004

### BACKGROUND OF THE INVENTION

1. Field of the Invention

The invention relates generally to seeding apparatus but more particularly to an improved back plate fitted on a finger type seed meter.

2. Background of the Invention

When planting corn and other row crops, it is essential to place the seeds in the ground with uniform spacing between the seeds to ensure an even growth and maximum crop yield. To do so, a number of inventions have tackled the problem, at this point, the most practical method found is to use a disk rotating in a vertical plane which pushes seeds out through a small hole from where the seeds fall into the soil.

Over the years, other inventors have added improvements such as having improved seating for individual seeds in seed cells on the periphery of the seed disc as the seed disc rotates through the seed reservoir. Improvements also include a barrier brush for preventing seeds from entering the delivery tube directly from the reservoir, and a brush holder which limits the effective width of a peripheral retainer brush so that the retainer brush cannot retain two seeds simultaneously in the same seed cell.

Another invention boasts an axial inner wall, a radial outer wall and a flexible radial inner wall wherein singled seeds are trapped in a seed trapping area. A flexible and resilient insert together with an axially extending brush removes excess seeds from the seed receiving cells as they pass through the seed puddle before entering the seed trapping area.

Another invention has a backing plate having a cutout section and a plurality of variable inserts to get accurate seed spacing of a variety of size and shapes of seeds. Each insert of the meter includes a seed release area having varied shapes and depths of projections and depressions to accomplish accurate and timely release from the fingers of seeds of various sizes and shapes. The exit void being varied both in dimension and contour to substantially eliminate seed rejections and to ensure seed ejection into a seed tube.

Each type of seeds having specific shapes and sizes, it is difficult to find a single planter which will work perfectly for each type of seeds and one has to constantly change the finger wheel or the back plate or both in order to reduce to a minimum rebound or jamming which makes the seeds skip the normal evenly spaced row seeding.

### SUMMARY OF THE INVENTION

In view of the foregoing disadvantages inherent in the known devices now present in the prior art, the present invention, which will be described subsequently in greater detail, is to provide objects and advantages which are:

To change the orientation of seeds along their sides so that they present a more uniform profile for improved grasping.

To provide a funneling means to reorient the seeds along their lengths to further improve grasping.

To attain these ends, the present invention generally comprises a modified back plate wall having a circumferential groove on over half of the inner perimeter. This groove helps in improving the way seeds are presented to fingers and ultimately the exit hole. It reduces the incidence of jamming of seeds or of seeds being missed by the fingers which take seeds to the exit hole. This groove has three main variations to accomodate various sizes and shapes of seeds: A groove with and added side bump which rotates flat seeds so that their flat side is parallel to the bottom of the groove, a groove with a narrowing which funnels the seeds for a better grasping by the fingers, and a groove with a combination side bump and narrowing.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE PREFERRED EMBODIMENT

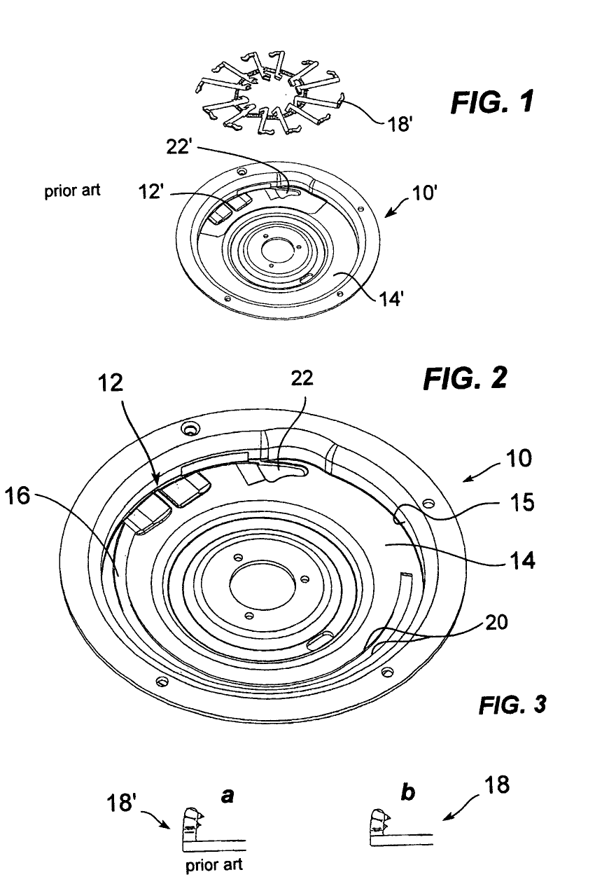

FIG. 1 Exploded orthogonal view of a back plate and finger wheel of the prior art.

FIG. 2 Orthogonal view of a back plate with a groove.

FIG. 3ab Front views of a finger of the prior art and of this invention respectively.

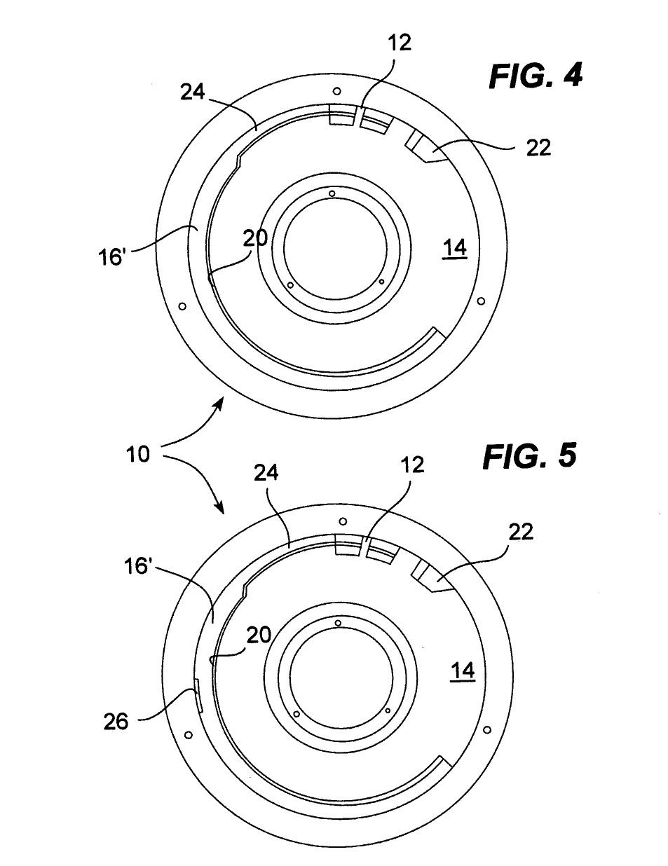

FIG. 4 Top view of a second variation of the groove with the side bump

FIG. 5 Top view of a third variation of the groove with both the side bump and narrowing.

### DETAILED DESCRIPTION OF THE PREFERRED EMBODIMENT

In FIG. 1, the prior art teaches the use of back plates (10′) set vertically over a seeding machines (not shown), having an exit hole (22′) for seeds, a combination bumps and depressed part (12′), a wall (14′), and a daisy wheel arrangement of fingers (18′). This instant invention also has a back plate (10) configured, sized, and oriented vertically to fit over an existing seeding machine, and a combination bumps and depressed part (12) situated on a wall (14) of the back plate (10), but with an added circumferential groove (16) which traces a path on the wall (14). This groove (16) helps in reorienting the seeds that are presented to fingers (18) and ultimately the exit hole (22). The circumferential groove (16) can be machined into the wall (14) or moulded, or stamped during the manufacturing process of the back plate (10). Although not essential for all types of grain, it is recommended that the circumferential groove (16) not present a sharp edge but rather rounded softened edges (20) so as to reduce the tendency of grain to get snagged over an otherwise sharp edge. Since the circumferential groove (16) changes the dynamics of the moving seeds, it is preferable to use new shorter fingers (18) as per FIG. 3b, otherwise identical to the fingers of the prior art (18′), as per FIG. 3a, in that they rotate against the back plate (10). The combination bumps and depressed part (12) is of course configured so as to accomodate the groove (16) and shorter fingers (18). The width of the groove (16) and the contour of the combination bumps and depressed part (12) are configured as an ensemble optimized for certain types of seeds. Thus there may exist a variety of back plates (10), each having a circumferential groove (16) and a combination bumps depressed part (12) being configured and sized appropriately for the seeds being used. Also the length of the fingers (18) although they remain usually shorter than the fingers (18′) of the prior art. Since farmers specialize in certain types of crops, only one type of back plate (10) may be required by a farmer.

To further accomodate the various sizes and shapes of seeds, the circumferential groove (16) has a number of possible variations including that shown in FIG. 4 wherein the circumferential groove (16′) is set at hte outside periphery of the wall (14) has a narrower section (24) which leads to the bump and depressed part (12). This narrower section has been found to improve the picking up of the grain by the fingers (18) since the grain is pushed against the side (15) of the back plate (10) and is forced to be picked by the fingers (18).

FIG. 5 shows the same circumferential groove (16) with a narrower section (24) but with the addition of a side bump (26) upon which interacts the wide side of a seed. Upon hitting the side bump (26), a seed will turn sideways so that its flat side is parallel to the bottom of the circumferential groove (16′). It is of course possible to have a groove (16) as per FIG. 2 that has a narrower section (24) which would favor yet another type of seeds.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. For example, a circumferential groove (16) being the key element, whether there is a narrower section (24) or not or the presence or not of a side bump (26) in the circumferential groove (16) still makes it still the circumferential groove (16), and the same applies whether it is set a the outer periphery of the wall (14) or not.

1. A finger type seed meter back plate seeding device having a finger pickup type seed metering device with a plurality of fingers mounted for rotation against a back plate, said back plate having a combination bumps and depressed part situated on a wall part of said back plate, and a hole through which exit the seeds, wherein:
a circumferential groove for reorienting seeds being presented to said fingers;
said circumferential groove tracing a path on said wall.

2. A finger type seed meter back plate seeding device as in claim 1 wherein:
said circumferential groove having rounded softened edges.

3. A finger type seed meter back plate seeding device as in claim 1 wherein:
said circumferential groove having a narrower section leading to said bump and depressed part.

4. A finger type seed meter back plate seeding device as in claim 1 wherein:
a side bump within said circumferential groove interacting with the wide side of a seed.

5. A finger type seed meter back plate seeding device as in claim 1 wherein:
a side bump within said circumferential groove interacting with the wide side of a seed, and said circumferential groove having a narrower section leading to said bump and depressed part.

6. A finger type seed meter back plate seeding device as in claim 2 wherein:
said circumferential groove having a narrower section leading to said bump and depressed part.

7. A finger type seed meter back plate seeding device as in claim 2 wherein:
a side bump within said circumferential groove interacting with the wide side of a seed.

8. A finger type seed meter back plate seeding device as in claim 2 wherein:
a side bump within said circumferential groove interacting with the wide side of a seed, and said circumferential groove having a narrower section leading to said bump and depressed part.
